(19) United States
(12) Patent Application Publication
(10) Pub. No.: US 2007/0162345 A1
(43) Pub. Date: Jul. 12, 2007

(54) Tax refund system and method

(75) Inventors: Pi-Chuan Hung, Taichung City (TW); Chung-En Kao, Taipei City (TW); Hui-Chuan Chen, Hsinchu City (TW); I-Shinn Tien, Hsinchu City (TW); Chii-Yah Yuan, Hsinchu City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/505,850

(22) Filed: Aug. 18, 2006

(30) Foreign Application Priority Data
Dec. 16, 2005 (TW) 094144625

(51) Int. Cl. G06Q 20/00

(52) U.S. Cl. 705/17

(57) ABSTRACT

A tax refund system and method are disclosed. By the tax refund system of the present invention, a tax refund card embedded with memory is utilized to purchase merchandises in a tax-free shop so that the work of the tax-free shop can record the information relating to those purchased merchandises matching tax-refund regulations into the memory of the tax refund card for enabling the recorded information to be used as refund basis. The tax refund system and method can avoid the trouble of safekeeping many tax-return receipts while purchasing merchandises, and also it can facilitate tax refund procedure and thus enhanced the service convenience. Moreover, the tax refund card can be integrated with passports so that the certification of identity for tax-refund can be facilitated. Not only the marketing strategy and production planning can be promoted and scheduled according to the shopping records gathered from the tax refund cards, but also the shopping records can be used by authorities as reference for identifying abnormal shopping behavior.

### FIELD OF THE INVENTION

The present invention relates to a tax refund system and method, and more particularly, to a tax refund system and method capable of storing a shopping record of the shopper in a tax refund card embedded with radio frequency identification (RFID) tag.

### BACKGROUND OF THE INVENTION

As the consumption power is enhanced with the growth of economy and the distance between countries is shortened with the development of science and technology, traveling aboard has becoming a commonplace. Obviously, shopping is inevitable while traveling. It is known that, in most countries, a shopper do require to pay a sales tax in addition to the sale price of a merchant, which is usually a fixed percentage of the sale price and is collected as taxation.

Taking shopping while traveling abroad for instance, as different country has different sales tax refund regulations with specific procedures, all those regulations may be confusing and inconvenient for shoppers and have shortcomings concluded as following:
(1) The tax refund regulations of different countries are varied that is prone to cause confusion for a shopper: For instance, as a shopper is traveling in countries of European Union (EU), the refund regulations defined by those EU countries requires the shopper to have all his/her sales tax of shopping applied and refunded at the last EU country of his/her journey. However, if there is a country visited by the shopper during his/her journey is a non-EU country, the tax refund of the relating shopping of the shopper in that non-EU country should be performed in the specified tax refund office of that non-EU country respectively as soon as he/she is leaving the country. Moreover, some countries require the shopper to have his/her tax refund directly at a store where the shopping is performed, but under the condition that a minimum amount of spending is satisfied.
(2) Various receipts, forms and refund checks issued by different retailers for a shopper to keep can be a torment: since current tax refund regulations adopted by most countries require a shopper to keep and present all his/her shopping receipts for applying tax refund and one shopping operation performed by the shopper in one store might generate more than one receipt papers whereas the forms of the receipt papers are different in different stores, the trouble of keeping all those various and numerous receipts might cause the shopper to think twice before shopping.
(3) Slow tax refund procedures can be a waste of time: current tax refund procedures of almost every country requires a shopper to bring his/her shopping receipts merchandise to the taxation bureau at the last point of departure from the visited jurisdiction as each purchased merchandise will be examined with reference to the shopping receipts for determining the sales tax relating to the examined merchandise can be refunded. The item-by-item procedure is not only a waste of manpower, but also will consume a conceivable amount of time that might sometimes delay the departure of the shopper.

Therefore, it is in great need to have a novel tax refund system and method for shoppers.

### SUMMARY OF THE INVENTION

The present invention provides a tax refund system and method, capable of reducing the amount of receipts required to be kept for tax refund and shortening the time required for a tax refund procedure by storing shopping records in a tax refund card embedded with radio frequency identification (RFID) tag while utilizing an electronic mechanism with tax refund evaluation and calculation abilities for enabling a tax refund to be calculated with respect to the stored stopping record.

Moreover, by the tax refund system and method provided in the present invention, not only the tax refund card can be used as identity certification during the performing of a tax refund procedure for preventing forgery, but also the shopping data stored in a tax refund card can be analyzed by a means of data mining so as to form a report relating to shopping habits, preferences, and shopping abnormalities.

To achieve the above objects, the present invention provides a tax refund system, which comprises: at least a tax refund card, each for recording an identification data and a shopping record; a first reader/writer, disposed in a store, capable of accessing the identification data stored in the tax refund card while being enabled to write a shopping data into the shopping record and accessing content stored in an identification tag arranged at a merchandise of the store; at least a second reader/writer, disposed in a tax refund booth (e.g. a taxation bureau stationed in an airport), capable of accessing information stored in the tax refund card; and a server, electrically connected to the second reader/writer; wherein, the server further comprises: a tax refund logistic module, for receiving information accessed by the second reader/writer so as to use the received information to perform an operation of tax refund evaluation and calculation; and an object name service (ONS) module, connected to a merchandise database, being enabled to receive merchandise-related data of the information accessed by the second reader/writer while searching the merchandise database to find merchandise names matching to the received merchandise-related data.

In addition, the present invention further provides a tax refund method, which comprises steps of:
using a tax refund card storing an identification data and a shopping record for performing a shopping operation at a store;
enabling a clerk of the store to use a first reader/writer for accessing the identification data for identity certification;
enabling the clerk to use the first reader/writer to read a tag of a merchandise to be purchased and then write a corresponding shopping data into the shopping record;
using the tax refund card to perform a tax refund operation at a tax refund booth;
utilizing a second reader/writer to access identification data and shopping record of the tax refund card at the tax refund booth while transmitting the accessed data to a server; and
enabling the server to use an object name service (ONS) module connected to a merchandise database for finding merchandise names matching to the accessed shopping record from the merchandise database, while enabling a tax refund logistic module to refer to the access shopping data for perform an operation of tax refund evaluation and calculation.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram illustrating the architecture of a tax refund system according to a preferred embodiment of the invention.

FIG. 2 is a schematic diagram illustrating the architecture of a server adapted to be used in a tax refund system according to the present invention.

FIG. 3 is a schematic diagram illustrating the architectures of a shopping data mining module and a abnormal shopping evaluation module, both being adapted to be used in a tax refund system, according to the present invention.

FIG. 4 is a schematic diagram depicting an operating framework of a tax refund method according to the present invention.

FIG. 5 is a flow chart depicting the tax refund steps of a tax refund operation according to a tax refund method of the present invention.

FIG. 6A is a flow chart depicting the tax refund steps of a tax refund method according to a first preferred embodiment of the present invention.

FIG. 6B is a flow chart depicting the tax refund steps of a tax refund method according to a second preferred embodiment of the present invention.

FIG. 6C is a flow chart depicting the steps of data analysis of a tax refund method according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

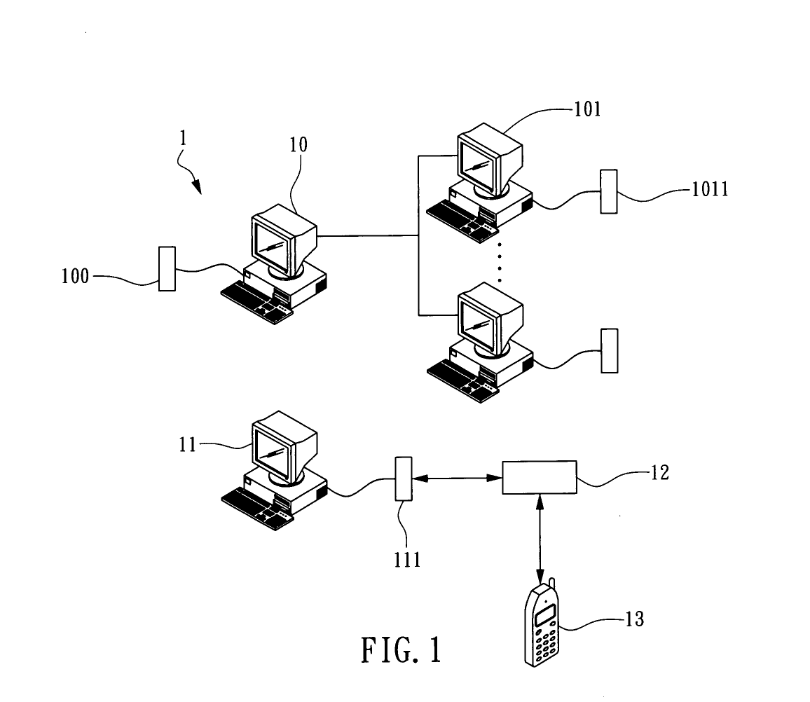

Please refer to FIG. 1, which is a schematic diagram illustrating the architecture of a tax refund system according to a preferred embodiment of the invention. The tax refund system 1 of FIG. 1 is comprised of: at least a tax refund card 12, a first reader/writer 11, at least a second reader/writer represented by the two readers 100, 1011, and a server 10. For facilitating the tax refund card 12 to be embedded in a passport of a shopper, the size of the tax refund card should be designed to be fit to the passport easily and rapidly. The tax refund card 12 can record an identification data and a shopping record of a shopper by the use of a radio frequency identification (RFID) tag. Moreover, the tax refund card 12 can be a combo card with ability of a credit card, debit card, and so on. It is preferred that the identification data should include personal data registered in the passport of the shopper so as to be used as identity certification of tax refund; and the shopping record should include information of shopping location, shopping time, item purchased, amount of each item purchased, and shopping total, etc., but is not limited thereby. In addition, the tax refund card 12 is equipped with administrating ability for entrusting different accessing authorizations to the shopper, stores, and taxation bureaus.

In FIG. 1, the first reader/writer 111 is arranged in a store and is connected to a terminal 11, which is capable of accessing the identification data stored in the tax refund card 12 while being enabled to write a shopping data into the corresponding fields of the shopping record, such as fields of shopping location, shopping time, item purchased, amount of each item purchased, and shopping total, etc. Further, the first reader/writer 111 is capable of accessing content stored in an identification tag arranged at a merchandise of the store, whereas the identification tag of a merchandise can be a bar code label or a RFID tag. In the preferred embodiment shown in FIG. 1, the first reader/writer 111 is a RFID reader/writer that it is able to utilize a point-of-sale (POS) system to write data relating to a shopping of the shopper into the shopping record. Furthermore, the first reader/writer 111 is comprised of: a bar code reader, for reading a bar code of a merchandise while transmitting the reading to the POS system; and a radio frequency writer, capable of utilizing the POS system to write data relating to a shopping of the shopper into the shopping record.

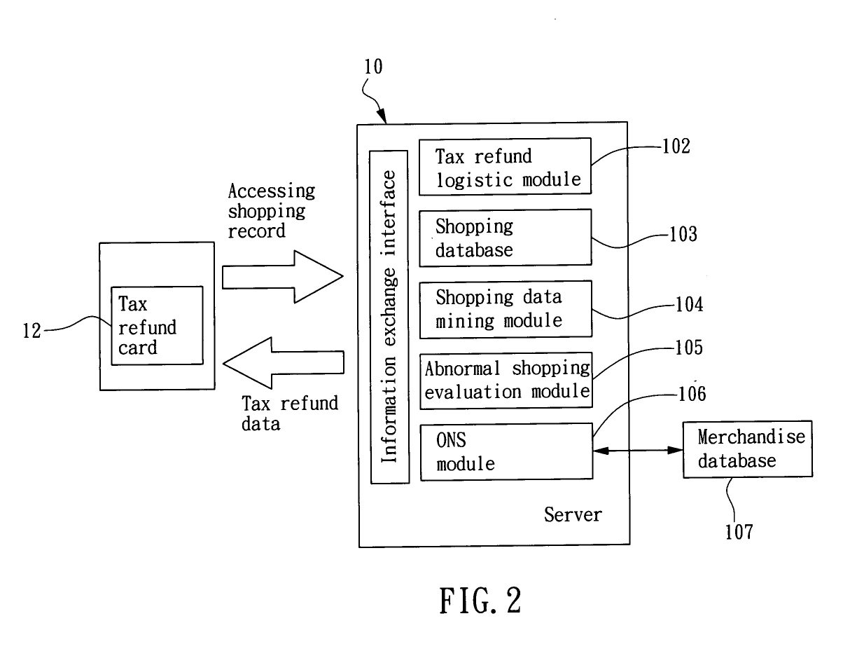

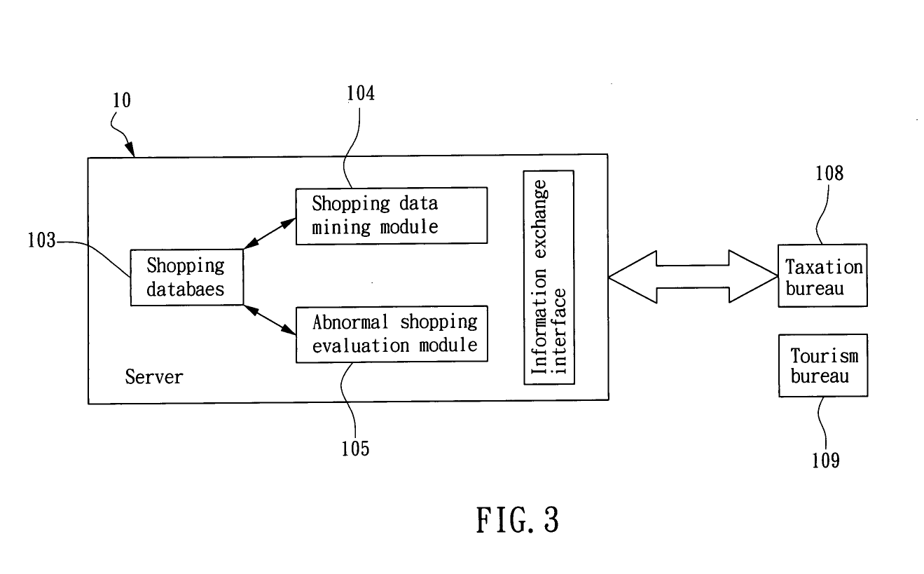

Moreover, the second reader/writers 100, 1011 are arranged at a tax refund booth of a jurisdiction, which are capable of accessing information stored in the tax refund card 12. In the preferred embodiment shown in FIG. 1, the server 10 is electrically connected to the second reader/writer 100 for enabling the server 10 to receive the content of the tax refund card 12 that is accessed by the second reader/writer 100. Please refer to FIG. 2, which is a schematic diagram illustrating the architecture of a server adapted to be used in a tax refund system according to the present invention. As seen in FIG. 2, the server 10 further comprises: a tax refund logistic module 102, a shopping database 103, a shopping data mining module 104, an abnormal shopping evaluation module 105 and an object name service (ONS) module 106.

Wherein, the tax refund logistic module 102 is used for receiving information accessed by the second reader/writer 100 so as to use the received information to perform an operation of tax refund evaluation and calculation; and the object name service (ONS) module 103 is connected to a merchandise database so as to be enabled to receive merchandise-related data of the information accessed by the second reader/writer 100 while searching the merchandise database 107 to find merchandise names matching to the received merchandise-related data and registering the obtained name to shopping database 103. Please refer to FIG. 3, which is a schematic diagram illustrating the architectures of a shopping data mining module and an abnormal shopping evaluation module, both being adapted to be used in a tax refund system, according to the present invention. As seen in FIG. 3, the shopping database 103 can record shopping data of the shopper for providing the shopping data mining module 104 and the abnormal shopping evaluation module 105 to perform a data mining operation thereupon.

The shopping data mining module 104 is enabled to access the information stored in the shopping database 103 while performing a data analysis with reference to the nationality, gender, and traveling season of the shopper to form a report relating to the shopping habit and preferences of the shopper, such that the report can be used as a reference of tourism program or inventory of a retail, store. The abnormal shopping evaluation module 105 is enabled to access the information stored in the shopping database 103 so as to use the access information to perform an evaluation for determining whether the shopping behavior of the shopper is abnormal, such that the shopper with abnormal shopping behavior can be inspect. As seen in FIG.1, the server 10 can be connected to more than one terminals for enabling the connecting of more than one shoppers simultaneously while each terminal is connected to a second reader/writer 1011.

In the preferred embodiment shown in FIG. 1, a handheld device 13 is enabled to be used by the shopper for accessing the content of the tax refund card 12 while editing and browsing through the shopping record stored therein by the use of a human-machine interface. Wherein, the handheld device 13 further comprises a tax refund logistic module, which is capable of performing an operation of tax refund evaluation and calculation; and the human-machine interface can be a java interface, but is not limited thereby. Moreover, the handheld device 13 can be a device selected from the group consisting of a personal digital assistant (PDA), a cellular phone, and a notebook computer.

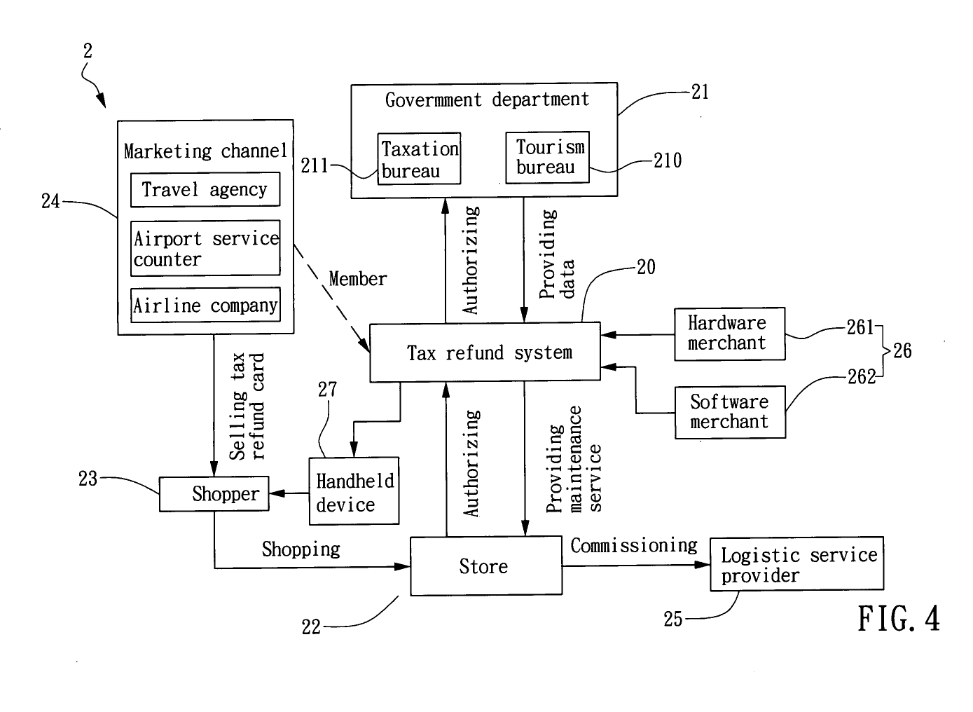

Please refer to FIG. 4, which is a schematic diagram depicting an operating framework of a tax refund method according to the present invention. In FIG. 4, operating framework 2 involves the work of government departments 21, shoppers 23, marketing channel 24, tax return stores 22 and logistic service providers 25 that respectively is in charge of an operation as describe in the following:
(1) The government department 21 is in charge of the issuing of tax refund card. For instance, a taxation bureau of a jurisdiction can authorize a tax refund service company with tax refund system 20 or a bank to issue and provide the tax refund card.
(2) The tax refund card can be made available through a marketing channel 24. For instance, the tax refund card can be obtained from those specific counters disposed at specific locations, such as an airport, by the authorized tax refund service company, or from the travel agencies, bank branches, airline companies, all commissioned as members of the authorized tax refund service company.
(3) The authorized tax refund service company is responsible to provide a tax refund system 20, and the tax refund system 20 should be available at every tax refund booth of the jurisdiction, such as taxation offices arranged at an airport, an outpost on a highway, a harbor, or a railroad station. Wherein, the system 20 should include at least a server, which should further be connected to a plurality of terminals. It is noted that the authorized tax refund service company is free to commission several supporting providers of hardware and software merchants for constructing the tax refund system 20.
(4) The device for accessing the tax refund card as well as its relating operating software that is required by retail stores 22 should be maintained and provided by the authorized tax refund service company. However, the maintenance and updating of merchandise data are the responsibility of the retail stores 22.
(5) The shoppers 23 having the tax refund card should be able to read and edit the content stored therein by a handheld device 27. In the preferred embodiment of the invention, the handheld device 27 is provided by the authorized tax refund service company, but is not limited thereby.
(6) The government departments, such as the taxation bureau 211 and the tourism bureau 210, should be able to access the shopping records of each shoppers traveling in its jurisdiction so as to be alerted by the abnormal shopping behaviors.

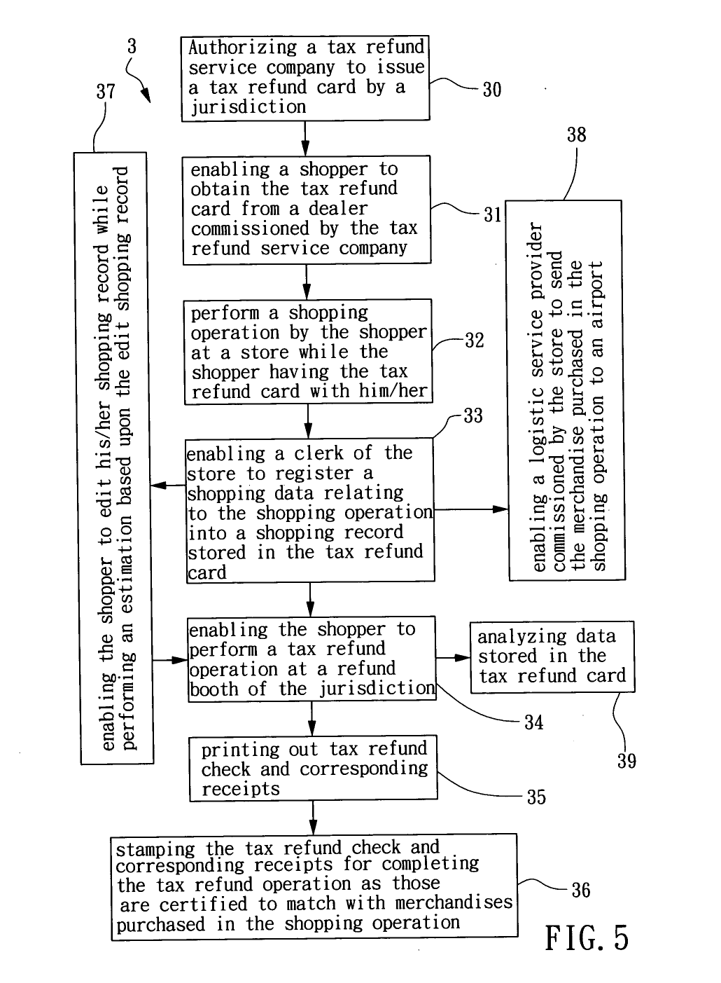

By the aforesaid system and operating framework. A shopper tax refund method can be provided as shown in FIG. 5. In FIG. 5, a flow chart depicting the steps of a tax refund operation 3 according to the tax refund method of the present invention is disclosed. The flow of the tax refund operation starts at step 30. At step 30, a tax refund service company is authorized to issue a tax refund card embedded with a RFID tag by a taxation bureau of a jurisdiction, and then the flow proceeds to step 31. It is noted that the tax refund card can be a combo card combining ability of a credit card or debit card. At step 31, a shopper is enabled to obtain the tax refund card from a dealer commissioned by the tax refund service company, and then the flow proceeds to step 32. According to a preferred embodiment of the invention, the tax refund card designated for specific jurisdictions can be made available to a shopper at a ticketing office as the shopper is purchasing airplane tickets for his/her trip, or at a service counter of an airport where the shopper enters the jurisdiction, such that the tax refund card can be initiated by a service personnel authorized by the taxation bureau of the jurisdiction for enabling the tax refund card for the shopper. At step 32, the shopper is enabled to perform a shopping operation using the tax refund card at a tax-free store, and then the flow proceeds to step 33.

At step 33, as the shopping operation of the shopper is completed, the shopper will present his/her tax refund card to a clerk of the tax-free store for identification and billing, and then as soon as the identity of the shopper is certified, the clerk is enabled to register shopping data of the shopping operation matching the tax refund regulation of the jurisdiction into a shopping record stored in the tax refund card, whereas the clerk will only register those merchandises that can be refunded according to the tax refund regulation into the tax refund card. It is noted that any clerk of any tax-free store is not authorized to have access to shopping data of the shopper that are not performed at one's store, and the terminal used in the tax-free store of accessing tax refund card is preferably connected to a printing device for printing tax refund check and relating receipts. Moreover, by the fluent procedures of step 32 and step 33, the shopper is able to obtain his/her tax refund check faster than before. After the shopper finishes his/her shopping at the tax-free shop, the shopper is enabled to edit his/her shopping record while performing an estimation based upon the edit shopping record as shown in step 37; or if there are certain merchandises that are too big to carry or are specified in the tax-refund regulation are send directly to an airport where that shopper is designated to depart from the jurisdiction by a logistic service provider commissioned by the tax-free store as shown in step 38.

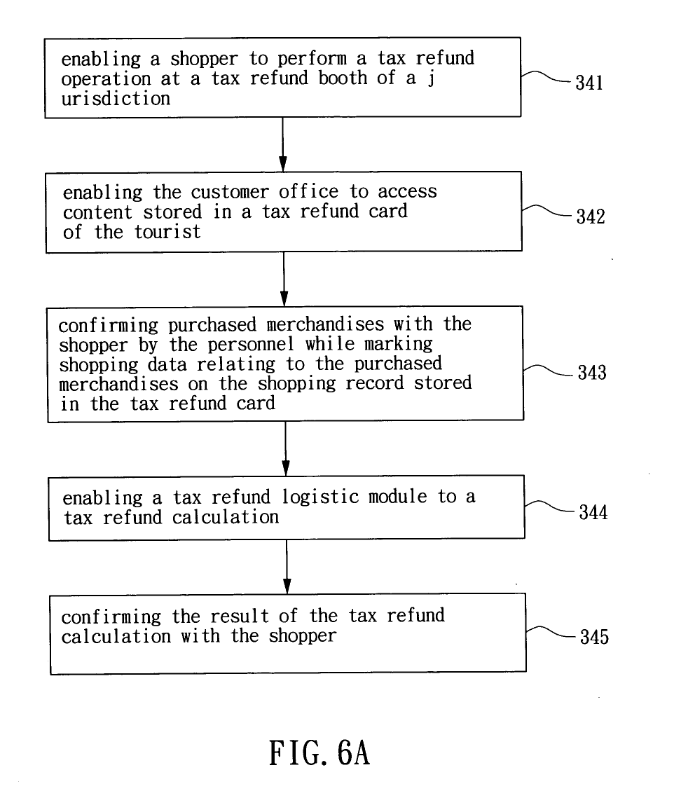

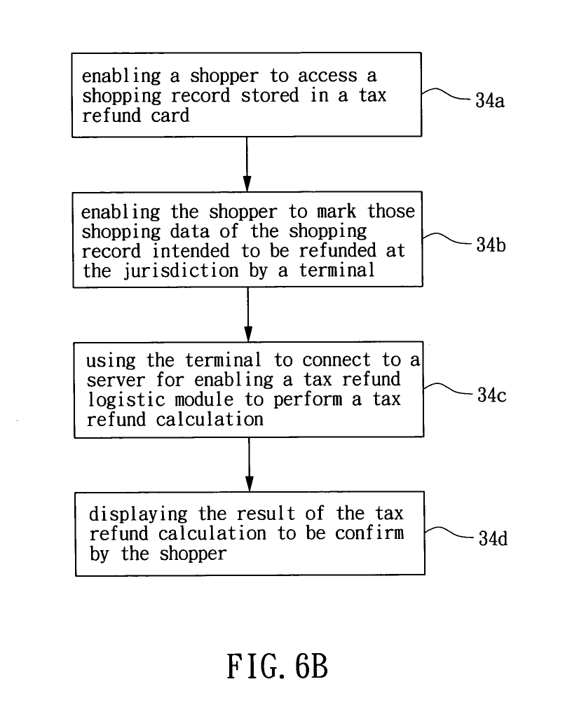

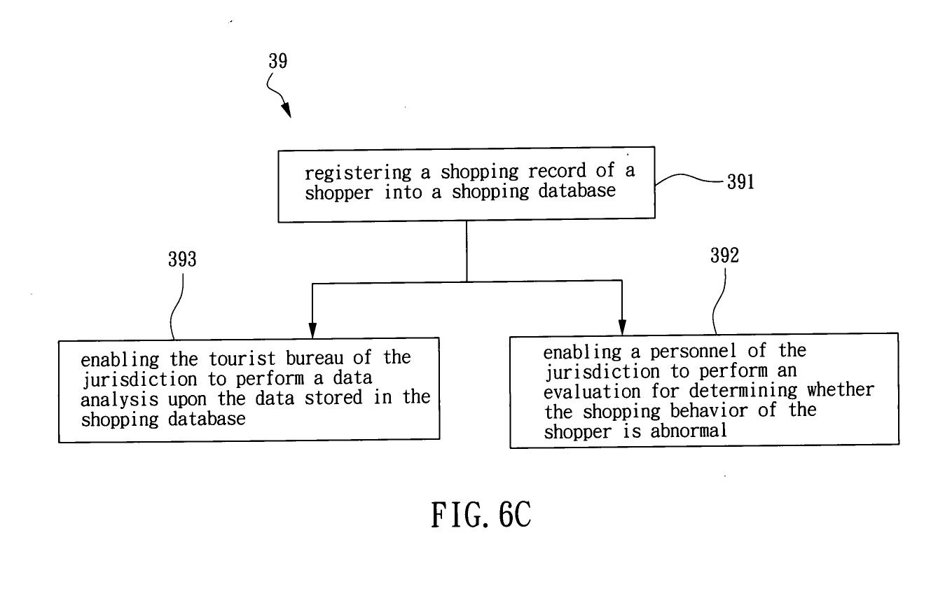

As seen in FIG. 5, after the shopper had finished all his/her shopping and is departing the jurisdiction as steps shown in step 33 and step 37, the flow proceeds to step 34. At step 34, the shopper is enabled to perform a tax refund operation at a refund booth of the jurisdiction while the shopping record of the shopper is being made available for analysis as shown in step 39, and then the flow proceeds to step 35. For clarity, a detailed tax refund operation according to a first preferred embodiment of the invention is shown in FIG. 6A. In this first preferred embodiment, the shopper is enabled to perform his/her tax refund operation at a tax refund booth, whereas the tax refund booth can be arranged at an airport, an outpost on a highway, a harbor, or a railroad station, etc., and is assisted by a personnel of the taxation bureau. The tax refund operation of the shopper starts at step 341. At step 341, a shopper is enabled to perform a tax refund operation at a refund booth of a jurisdiction while being assisted by a personnel of the taxation bureau, and then the flow proceeds to step 342. It is noted that the personnel of the taxation bureau is able to use a terminal arranged at the tax refund booth to communicate with a server by the use of a hyper text transfer protocol (HTTP) and an encryption mechanism for accessing, transmitting and displaying information of the shopper. Furthermore, the terminal is equipped with a reader/writer capable of interrogating to the RFID tag of the tax refund card.

At step 342, the personnel of the taxation bureau is enabled to access the identification information and shopping record of the shopper stored in a tax refund card of the shopper by the use of the terminal, and then the flow proceeds to step 343. At step 343, the personnel of the taxation bureau confirms the identity and purchased merchandises with the shopper for marking, shopping data relating to the purchased merchandises on the shopping record stored in the tax refund card through the displaying device of the terminal, and then the flow proceeds to step 344. At step 344, a tax refund logistic module is enabled to perform a tax refund calculation upon the marked shopping data of the shopping record of the shopper while displaying the result of the calculation on the displaying device of the terminal, and then the flow proceeds to step 345. At step 345, the shopper checks and confirm the result of the tax refund calculation.

In addition to the counter-service tax refund operation shown in FIG. 6A, there is a self-help tax refund operation as the steps shown in the second preferred embodiment of FIG. 6B. The self-help tax refund operation can be performed by a shopper without the assistance of a personnel of the taxation bureau, that is, the shopper can use a terminal arranged at a tax refund booth of a jurisdiction to communicate with a server by a hyper text transfer protocol (HTTP) and an encryption mechanism for accessing, transmitting and displaying information of the shopper.

The second embodiment of FIG. 6B starts at step 34a. At step 34a, a shopper is enabled to access his/her shopping record stored in his/her tax refund card, and then the flow proceeds to step 34b. At step 34b, the shopper is enabled to mark those shopping data of the shopping record intended to be refunded at the jurisdiction by a terminal, and then the flow proceeds to step 34c. At step 34c, the terminal is connected to a server for enabling a tax refund logistic module to perform a tax refund calculation upon the marked shopping data, and then the flow proceeds to step 34d. At step 34d, the result of the tax refund calculation is displayed on the terminal to be confirm by the shopper.

Back to the step shown in FIG. 5 while the flow is proceeding at step 35 after completing step 34. At step 35, tax refund checks and corresponding receipts will be printed out on the printing device connected to the terminal, and then the flow proceeds to step 36. At step 36, the tax refund check and corresponding receipts are stamped by the taxation bureau and handed by to the shopper for completing the tax refund operation while the writing-in ability of the tax refund card of the shopper relating to the jurisdiction where the tax refund operation is performed is deactivated.

Furthermore, the analysis perform in step 39 of FIG. 5 is detailed in steps shown in FIG. 6C. The analysis starts at step 391, where a shopping record of a shopper is registered into a shopping database of a jurisdiction, and then the flow proceeds to step 392 and step 393. At step 392, a personnel of the taxation bureau of a jurisdiction is enabled to perform an evaluation for determining whether the shopping behavior of the shopper is abnormal. At step 393, the tourism bureau of the jurisdiction is enabled to perform a data analysis upon the data stored in the shopping database for obtaining the shopping habit and preferences of the shopper.

To sum up, the present invention provides a shopper tax refund system and method capable of reducing the amount of receipts required to be kept by the shopper for tax refund and shortening the time required for a tax refund procedure by storing shopping records of the shopper in a tax refund card embedded with radio frequency identification (RFID) tag while utilizing an electronic mechanism with tax refund evaluation and calculation abilities for enabling a tax refund to be calculated with respect to the stored stopping record of the shopper.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tax refund system, comprising:
at least a tax refund card, each for recording an identification data and a shopping record;
a first reader/writer, disposed in a store, capable of accessing the identification data stored in the tax refund card while being enabled to write a shopping data into the shopping record and accessing content stored in an identification tag arranged at a merchandise of the store;
at least a second reader/writer, disposed in a tax refund booth, capable of accessing information stored in the tax refund card; and
a server, electrically connected to the second reader/writer, further comprising:
a tax refund logistic module, for receiving information accessed by the second reader/writer so as to use the received information to perform an operation of tax refund evaluation and calculation; and
an object name service (ONS) module, connected to a merchandise database, being enabled to receive merchandise-related data of the information accessed by the second reader/writer while searching the merchandise database to find merchandise names matching to the received merchandise-related data.

2. The tax refund system of claim 1, wherein the server further comprises:
a shopping database, for recording shopping data;
a shopping data mining module, being enabled to access the information stored in the shopping database while performing a data analysis with reference to the nationality, gender, and season so as to form a report relating to shopping habit and preferences; and
an abnormal shopping evaluation module, being enabled to access the information stored in the shopping database so as to use the accessed information to perform an evaluation for determining whether a shopping behavior is abnormal.

3. The tax refund system of claim 1, wherein the second reader/writer is further connected to a terminal embedded with a human-machine interface, while the terminal is further connected to the server, by which the human-machine interface of the terminal is used to communicate with the server through a communication protocol and an encryption mechanism for editing shopping record in a manner that at least a shopping data is selected therefrom to be used for tax refunding.

4. The tax refund system of claim 1, wherein the tax refund card is arranged at an article selected from the group consisting of a passport, a credit card, and a debit card.

5. The tax refund system of claim 1, wherein a handheld device is enabled to be used for accessing the content of the tax refund card while editing and browsing through the shopping record stored therein by the use of a human-machine interface.

6. The tax refund system of claim 5, wherein the human-machine interface is java interface.

7. The tax refund system of claim 5, wherein the handheld device further comprises: a tax refund logistic module, capable of performing an operation of tax refund evaluation and calculation.

8. The tax refund system of claim 1, wherein each of the first and the second reader/writer can be a radio frequency identification (RFID) reader/writer, and the first reader/writer is able to utilize a point-of-sale (POS) system to write shopping data relating into the shopping record.

9. The tax refund system of claim 1, wherein the first reader/writer further comprises:
a bar code reader, for reading a,bar code of a merchandise while transmitting the reading to a point-of-sale (POS) system; and
a radio frequency writer, capable of utilizing the POS system to write shopping data into the shopping record.

10. A tax refund method, which comprises steps of:
using a tax refund card storing an identification data and a shopping record for performing a shopping operation at a store;
enabling the store to use a first reader/writer for accessing the identification data for identity certification;
enabling the store to use the first reader/writer to read a tag of a merchandise to be purchased and then write a corresponding shopping data,into the shopping record;
using the tax refund card to perform a tax refund operation at a tax refund booth;
utilizing a second reader/writer to access identification data and shopping record of the tax refund card at the tax refund booth while transmitting the accessed data to a server; and
enabling the server to use an object name service (ONS) module connected to a merchandise database for finding merchandise names matching to the accessed shopping record from the merchandise database, while enabling a tax refund logistic module to refer to the access shopping data for perform an operation of tax refund evaluation and calculation.

11. The tax refund method of claim 10, further comprising steps of:
basing on the result of the operation of tax refund evaluation and calculation performed by the tax refund logistic module to print out a tax refund check and corresponding receipts; and
bring the printed tax refund check and the corresponding receipts to the tax refund booth so as to be used as certificate of tax refunding and thus complete the tax refund operation.

12. The tax refund method of claim 10, further comprising steps of:
enabling at least a terminal with the second reader/writer to connected to the server for facilitating a self-help tax refund operation to be performed; and
utilizing the terminal to mark those shopping data of the shopping record intended to be refunded.

13. The tax refund method of claim 10, further comprising steps of:
registering shopping data into a shopping database by the server;
enabling the server to use a shopping data mining module to search and analyze data stored in the shopping database so as to provide a report relating to the shopping habit and preferences; and
enabling the server to use an abnormal shopping evaluation module to search and analyze shopping data stored in the shopping database so as to form an evaluation for determining whether a shopping behavior is abnormal.

14. The tax refund method of claim 10, further comprising steps of:
using a handheld device to access the content of the tax refund card while editing and browsing through the shopping record stored therein by the use of a human-machine interface; and
enabling a tax refund logistic module embedded in the handheld device to perform an operation of tax refund evaluation and calculation.

15. The tax refund method of claim 14, wherein the human-machine interface is java interface.

16. The tax refund method of claim 10, wherein the first reader/writer is able to utilize a point-of-sale (POS) system to write shopping data into the shopping record.

17. The tax refund method of claim 16, wherein the first reader/writer further comprises:
a bar code reader, for reading a bar code of a merchandise while transmitting the reading to the point-of-sale (POS) system; and
a radio frequency writer, capable of utilizing the POS system to write shopping data into the shopping record.

18. The tax refund method of claim 10, wherein each of the first and the second reader/writer can be a radio frequency identification (RFID) reader/writer.

19. The tax refund method of claim 10, further comprising a step of:
informing a logistic service provider by the store to send merchandises purchased in the shopping operation to a specific location.

20. The tax refund method of claim 10, wherein the tax refund card is arranged at an article selected from the group consisting of a passport, a credit card, and a debit card.
